(19) United States
(12) Patent Application Publication
(10) Pub. No.: US 2021/0226242 A1
(43) Pub. Date: Jul. 22, 2021

(54) Systems, Devices, and/or Methods for Fuel Cell Utilizing Reactive Nano Silicate

(71) Applicant: HK Invent Inc., Ho Chi Minh City (VN)

(72) Inventors: Nguyen Khe, Ho Chi Minh City (VN); Hoai Vo Linh, Ho Chi Minh City (VN); Nguyen Trinh, Ho Chi Minh City (VN); Nguyen Tung, Ho Chi Minh City (VN); Nguyen Phu, Ho Chi Minh City (VN)

(73) Assignee: HK INVENT CORPORATION, Ho Chi Minh City (VN)

(21) Appl. No.: 16/794,828

(22) Filed: Feb. 19, 2020

Related U.S. Application Data
(60) Provisional application No. 62/963,446, filed on Jan. 20, 2020.

(51) Int. Cl. H01M 8/1051; H01M 8/1032; H01M 8/0606; H01G 9/028; H01G 9/20

(52) U.S. Cl. CPC H01M 8/1051; H01M 8/1032; H01M 8/0606; H01M 2008/1095; H01G 9/2018; H01G 9/2009; H01G 9/028

(57) ABSTRACT

Certain exemplary embodiments can provide a system, which comprises a device. The device comprises a solid electrolyte. The solid electrolyte comprises a reactive nano silicate precursor. The reactive nano silicate precursor is activated by a functional disturber. The functional disturber has a first end that is reactive with a silica/acid composite gel and a second end capable of transporting an ion.

### CROSS-REFERENCES TO RELATED APPLICATIONS

This application claims priority to, and incorporates by reference herein in its entirety, pending U.S. Provisional Patent Application Ser. No. 62/963,446 (Attorney Docket No. 1154-09), filed Jan. 20, 2020.

### BRIEF DESCRIPTION OF THE DRAWINGS

FIGS. 2-10 are executed in color. A wide variety of potential practical and useful embodiments will be more readily understood through the following detailed description of certain exemplary embodiments, with reference to the accompanying exemplary drawings in which:

FIG. 1 is a schematic diagram 1000 of an electron transfer model from SAC gel into a disturber molecule;

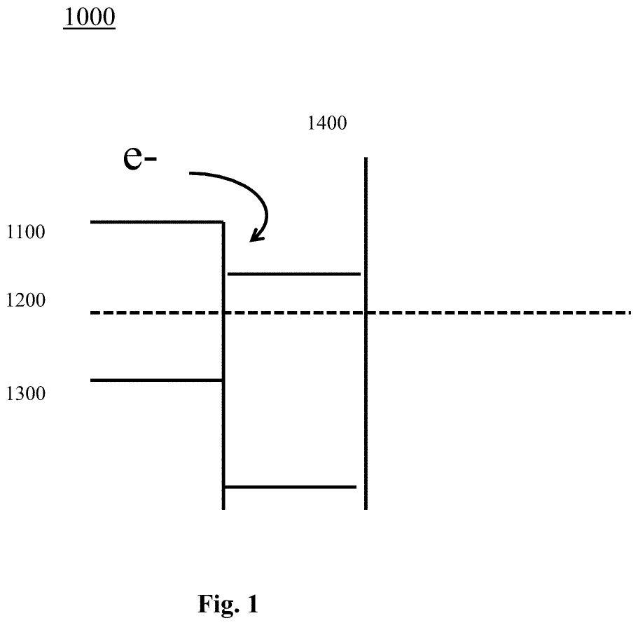

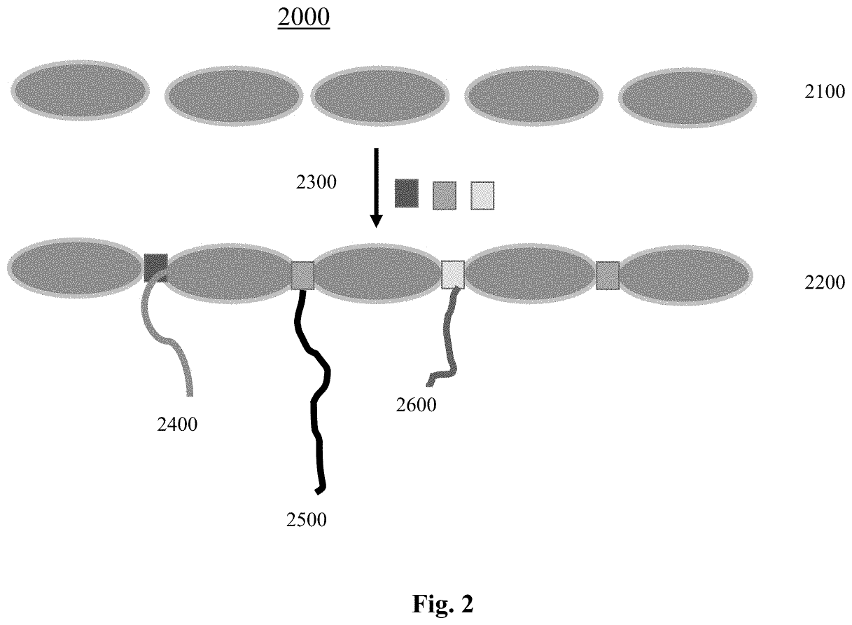

FIG. 2 is a schematic diagram 2000 of a high temperature ion transfer network based on reactive nano silicates;

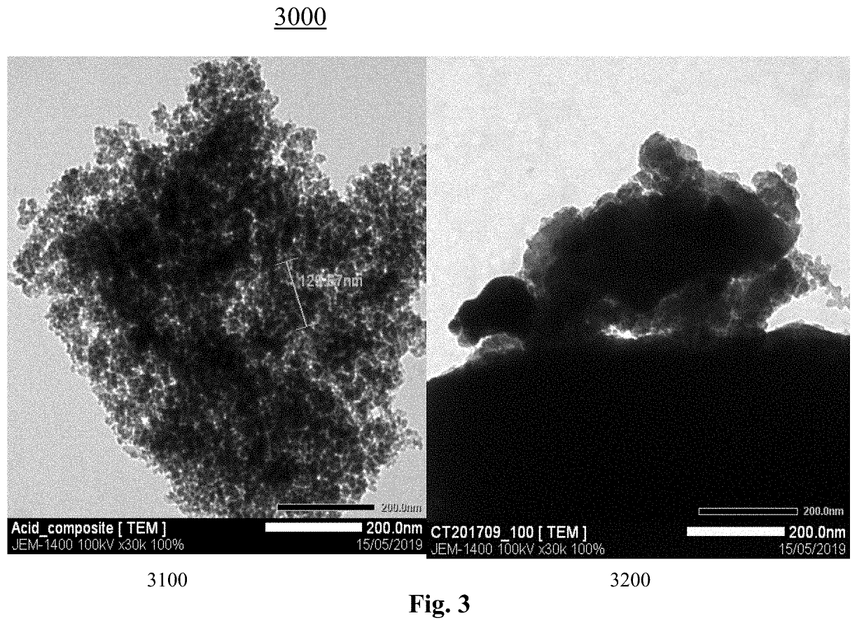

FIG. 3 is a transmission electron microscopy (“TEM”) image 3000 of SAC (left) and RNS (right) (scale 200 nm);

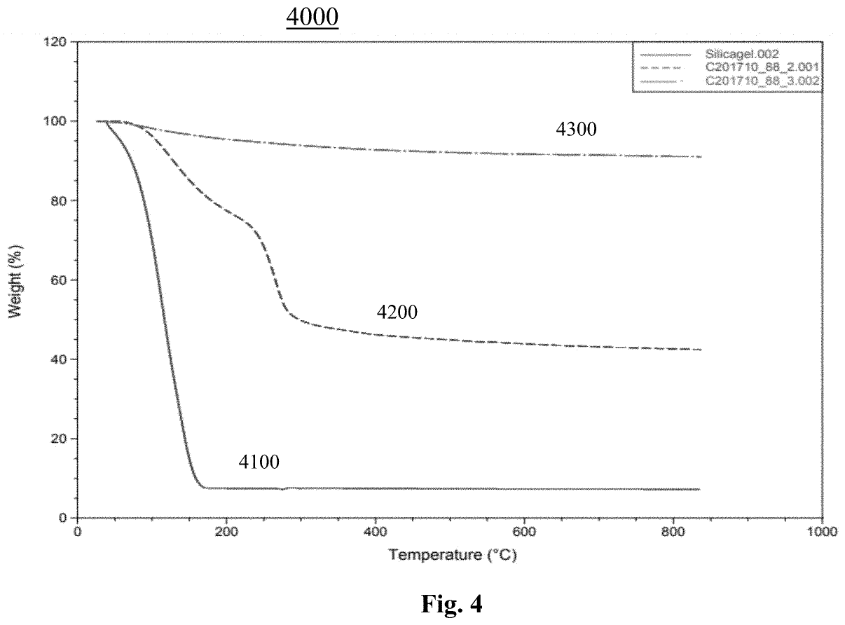

FIG. 4 is a graph 4000 of TGA data of exemplary SAC and RNS;

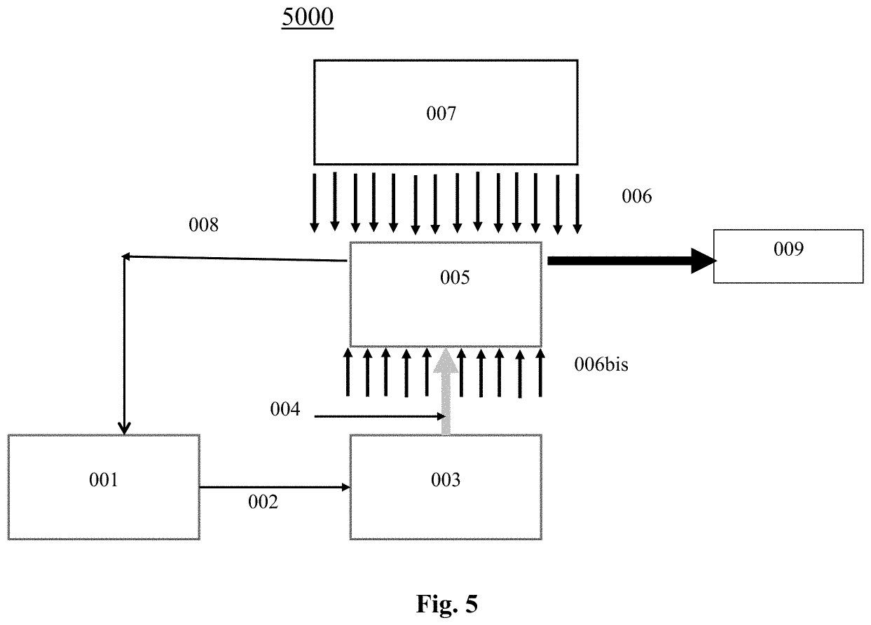

FIG. 5 is a schematic diagram 5000 of power generator operating with water;

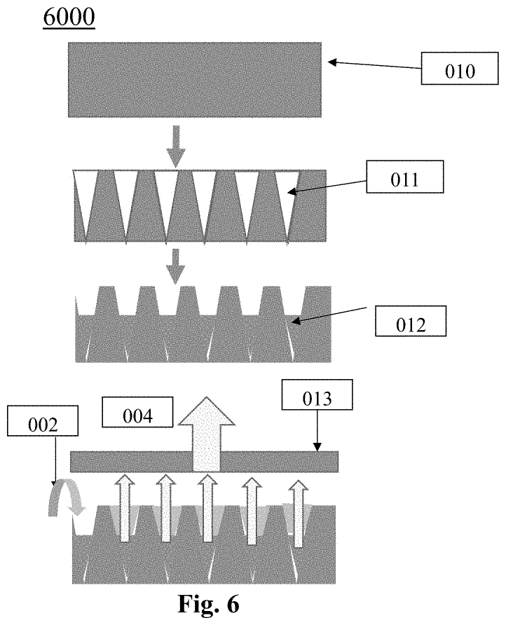

FIG. 6 is H2 gas generating cartridge 6000;

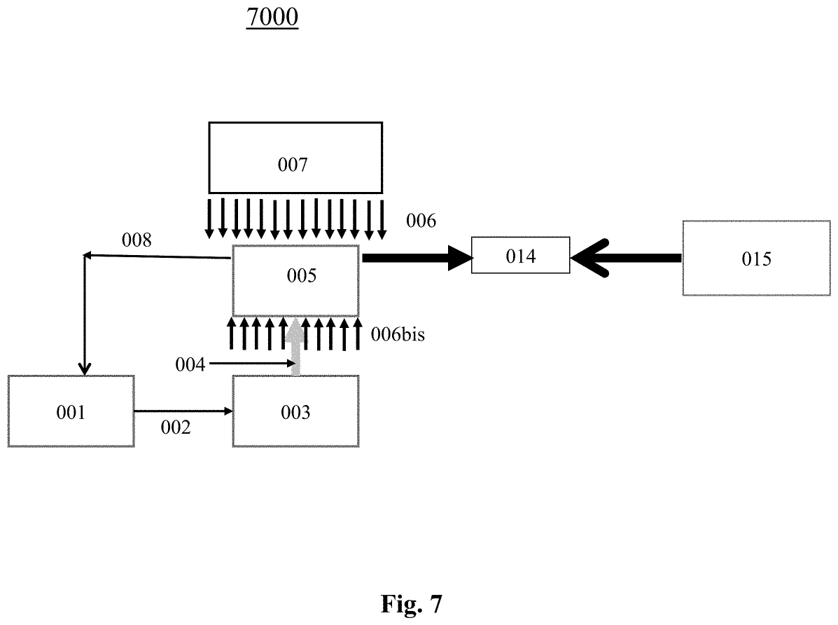

FIG. 7 is an exemplary hybrid power generator system 7000 from water and solar cell;

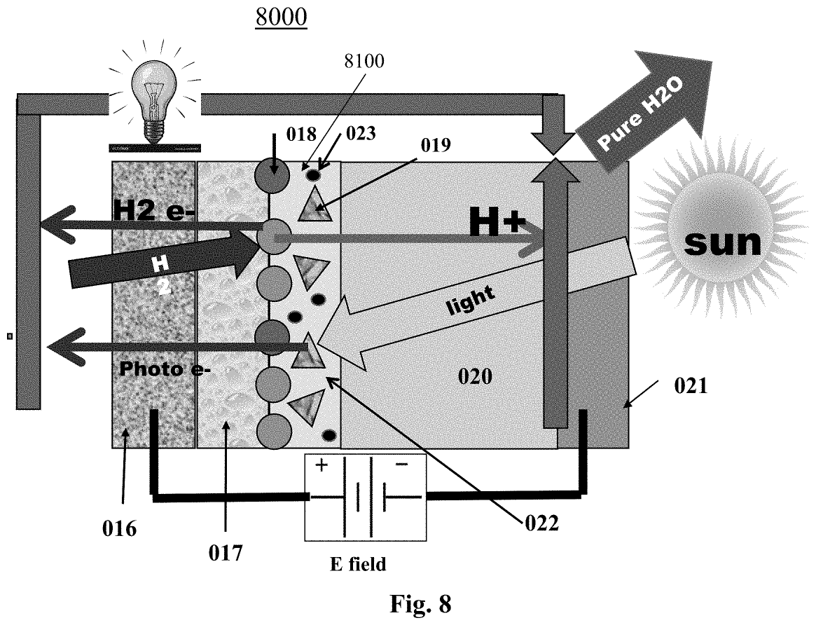

FIG. 8 is an exemplary hybrid power generator system 8000 from H2 fuel cell and AgX solar cell;

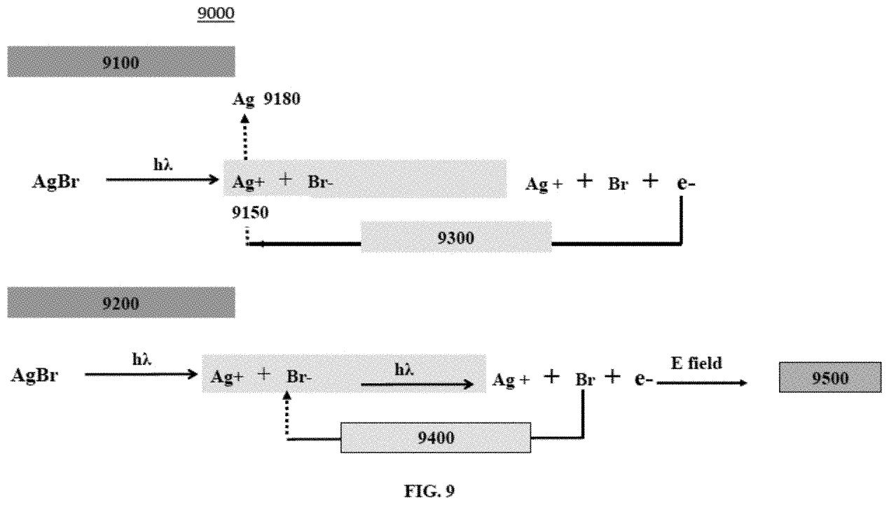

FIG. 9 is power generation mechanism 9000 of silver halide, AgX; and

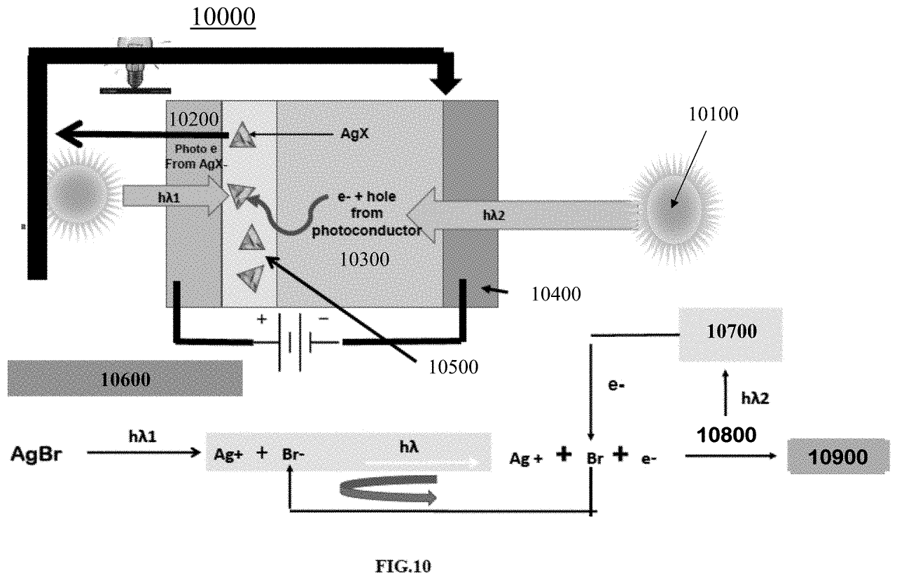

FIG. 10 is an exemplary system 10000.

### DETAILED DESCRIPTION

Certain exemplary embodiments can provide a system, which comprises a device. The device comprises a solid electrolyte. The solid electrolyte comprises a reactive nano silicate precursor. The reactive nano silicate precursor is activated by a functional disturber. The functional disturber has a first end that is reactive with a silica/acid composite gel and a second end capable of transporting an ion.

A proton transporter, Nafion (Nafion is a registered trademark of The Chemours Company FC, LLC, a Delaware limited liability company), for polymer electrolyte membrane (“PEM”) fuel cells (“PEMFC”) does not survive beyond approximately 90° C. and has limited power efficiency.

Certain exemplary embodiments provide a novel precursor for high temperature proton transporter.

Recently, molecularly disturbing a silica/acid composite (“SAC”) (as extracted from paddy husks originated in Viet Nam) with an electron acceptor metal oxide has rendered the SAC into a reactive nano silicate (“RNS”). SAC is disclosed in United States Patent Publication 20180099905, which is incorporated by reference herein in its entirety. RNS is self-reactive and thus forms a rigid film exhibiting interesting properties over raw materials; such as fireproof, flame retardant, waterproof, heat resistant, anti-ultraviolet, and weatherproof.

RNS can be formulated with a functional disturber into a proton transporter operating in a wide range of temperatures between room temperature and approximately 1000° C. for fuel cells.

In certain exemplary embodiments, a solid oxide fuel cell (“SOFC”) has been known to exhibit the advantage of producing high power from the ionization of fuel. However, a trade-off is a high operating temperature giving slow start up times. Also, high operating temperature requires high heat sources which consume energy and costly. The fabrication of SOFC can be complex.

On the other hand, a PEMFC can operate at low temperature (from approximately room temperature to approximately 90° C.) utilizing a polymer film (e.g., Nafion), which transports protons giving a fast start up time but limited power efficiency. The key functional group of Nafion, which transport proton is sulfonic acid —SO₃H.

Nafion is thermally decomposed at approximately 550° C. and the physical properties of Nafion is stable only up to approximately 90° C. and it is not a material that can be used in certain portions of a high power fuel cell.

Certain exemplary embodiments provide a novel ion transport material which can satisfy the industrial demand such as:
Power efficiency of greater than approximately 70%;
Fast start up time (within a few minutes or seconds);
Operating at intermediate temperature (between approximately 500-600° C.);
Easy fabrication; and
Low cost.

Certain exemplary embodiments provide a novel hybrid fuel cell, which can produce power without adding a costly high heat source.

Exemplary composite membranes for High Temperature PEM fuel cells and electrolyzers have been investigated (see, e.g., https://www.ncbi.nlm.nih.gov/pmc/articles/PMC6680835/). However, composite partners such as a metal organic frame work (“MOF”), poly benzimidazole, carbon based material can induce electron transport affecting proton mobility but not significantly contribute to improvement of physical properties of a PEM.

SAC Gel

United States Patent Publication 20180099905 discloses a nano material called SAC gel, which is a product extracted from paddy husks originated in Viet Nam utilizing alkaline and precipitated out with specific organic carboxylic acid. SAC gel can be a translucent white nano product having average particle size in the range of approximately 5-10 nm. The translucent SAC gel shows improvement of inkjet ink colorant but it doesn't form a film upon being dried and thus lacks of water proofing properties.

SAC Gel Disturber and Reactive Nano Silicate

U.S. patent application Ser. No. 16/457,983, which is incorporated by reference herein in its entirety, teaches further a next step to improve film forming properties of SAC gel can be by adding a disturbing molecule, which is capable of withdrawing an electron from SAC gel and rendering SAC gel into a reactive species, which can be called a Reactive Nano Silicate (“RNS”). As a result of increased reactivity, RNS exhibits excellent film forming properties with many other interesting features such as waterproofing, extended heat resistance beyond approximately 1000° C., flame retardance, and/or UV blocking, etc. RNS can act as an inorganic polymer, which can provide protection for many different materials against heat attack and/or mechanical damage, etc.

The disturber can act two roles:
withdrawing an electron from SAC gel and rendering the SAC gel into a more reactive species; and
connecting individual SAC gel particles together.

The electron withdrawing mechanism can be inferred in the electron transfer model described in FIG. 1. FIG. 1 is a schematic diagram 1000 of an electron transfer model from SAC gel into a disturber molecule. Diagram 1000 illustrates a conduction band 1100, a Fermi level 1200, a valence band 1300, and a disturber 1400. The disturber molecule of SAC gel can be selected from a group of metal oxides exhibiting electron-starving properties against SAC gel. Examples of effective disturbers are substances that comprise Fe₂O₃, Xe₂O, SnO₂, Al₂O₃, SiO₂, TiO₂, and/or a rare earth element oxide, etc.

RNS Based Electrolyte

Based on these observations, a new type of electrolyte can be designed as it is described in FIG. 2. FIG. 2 is a schematic diagram 2000 of a high temperature ion transfer network based on reactive nano silicates. Diagram 2000 illustrates a SAC gel 2100, a RNS 2200, a disturber 2300, a reactive proton transport polymer 2400, sulfonic acid functionalized silica 2500, and a metal oxide 2600. In certain exemplary embodiments, gel 2100 is not film forming. In certain exemplary embodiments, RNS 2200 is film forming.

According to the model of diagram 2000, SAC gel is the component of an RNS backbone and functional groups of a disturber act as RNS side chains. The disturber molecule can serve at least two functions:
be oxide functional to react with SAC gel; and
be ion transport functional:—SO₃H is utilized for proton transport and an oxide is utilized for oxygen ion transport.

Proton transport disturbers can have a general structure of:

SiO₂—X—SO₃H

### Where X is:

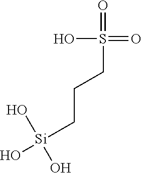 [SMILES: O=S(=O)(O)CCC[Si](O)(O)O]

3-(Trihydroxysilyl) propane-1-sulfonic Acid, 50% in water:

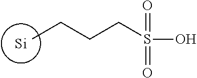

3-Propylsulfonic acid-functionalized silica gel:

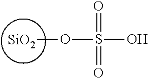

### Silica Sulfuric Acid.

### Sulfonic Acid Functionalized Nano Porous Silica.

For proton transport, electrocatalysts can be capable of ionizing H₂ gas into a proton H⁺ and an electron. An example of a functional disturber which can react with SAC gel can be a metal oxide with and without functional group such as, but not limited to, fume silica, sulfonic acid functionalized nano porous silica, sulfonic acid functionalized silica gel, silica sulfuric acid, 3-(Trihydroxysilyl) propane-1-sulfonic Acid, 3-Propylsulfonic acid-functionalized silica gel, and the like.

The following Si containing polymers can also work as proton transport disturber, which contains precursor to link —SO₃H with RNS:

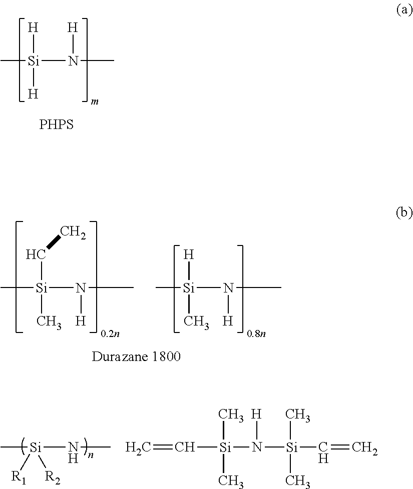

In order to incorporate a functional disturber into SAC gel to form RNS, certain exemplary embodiments dissolve SAC gel in alkaline and then add the disturber and disperse it at an elevated temperature. Some surfactant can be utilized to increase uniformity of the dispersion. Silica disturbers can be derivatives of silicate so they can get in a SAC gel chain very well. The amount of disturbers in RNS can vary from approximately 0.01% by weight to approximately 99% by weight, more preferably, between approximately 10% by weight and approximately 50% by weight.

Sulfonic acid functionalized silica, such as 3-(Trihydroxysilyl) propane-1-sulfonic Acid, have been investigated as proton transport for a direct methanol fuel cell. However, it had been used as naked material substantially without any reinforcement aid or protection. These materials are reported to have been attacked by liquid fuel.

Another type of proton transport disturber is reactive polymer having the formula (1):

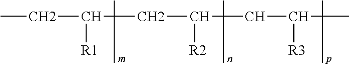

where: R1═H, —SO₃H, —NHSO₃H, —OSO₃H, -alkyl-SO₃H, R2═H, —OH, —CH₂CH₂OH, -alkyl-OH, —Cl R3═—OCOR4 in which R4=alkyl m>80, n<10.

See, e.g., 3-3-Triethoxysilylpropylaminopropane-1-sulfonic Acid-Polyvinyl alcohol Cross-Linked Zwitterionic Polymer Electrolyte Membranes for Direct Methanol Fuel Cell Applications, Bijay P Tripathi and Vinod K. Shahi, ACS Applied Materials & Interfaces 1(5):1002-12, May 2009. Such embodiments can utilize an immediate temperature (e.g., approximately 100-200° C.). However, these crosslinking polymers comprise an organic backbone, which are thermally decomposed at low temperature and might not be suitable for high temperature embodiments.

In certain exemplary embodiments, the precursor to add on the proton transport functional group to these polymers are chlorosulfonic acid and amino sulfonic acid derivatives through a reactive group —OH of poly vinyl alcohol (“PVA”) and a reactive group —Cl of poly vinyl chloride (“PVC”). These reactive functional groups can react with SAC gel as functional disturbers to link individual SAC gel particles into RNS.

Electron donor molecules and alkaline substances such as NaOH, KOH, sodium bicarbonate, CaCO₃, Ca(OH)₂, Al(OH)₃, ammonia borane, dichloroamine, hydroxylamine, monochloroamine, nitrogen trialogenide, etc. can be added to certain exemplary embodiments.

For oxygen ion transport, electrocatalysts can reduce O₂ gas into oxygen ion to be transported through an oxygen ion transporter such as yttria stabilized zirconia (YSZ), scandia stabilized zirconia (ScSZ), gadolinium doped ceria (GDC), and the like.

The connection of these oxygen ion transporters with SAC gel into functional RNS can form a new species. Overall, RNS can comprise SAC gel (silicate) connected by a disturber forming rigid backbone while the functional group of disturber is an ion transporter.

### Other High Temperature Elements

Insulating GHC

Besides RNS as high heat resistant binder, another heat resistant additive can be an insulating graphene hybrid composite (“GHC”) disclosed in U.S. Pat. No. 9,460,827, which is incorporated by reference herein in its entirety. In certain exemplary embodiments, high electrical conductive GHC can comprise approximately 5% by weight of a multi-walled carbon nanotube (“MWNT”) and approximately 95% graphene showing very low bulk electrical resistivity in the range of several ten mΩ to several mΩ Certain exemplary processes utilize a metal catalyst and high hydroxyl content materials as a carbon source. In an exemplary embodiment, a precursor was baked in low vacuum of approximately 10⁻² torr but high temperature of approximately 1200° C. However, in order to make non-electronic transport molecule, insulating GHC was made out of hydroxylated catalyst and baked at a temperature lower than approximately 550° C. This material did not transport electrons well and did not show harmful effects from proton transport. This insulating GHC exhibited a bulk electrical resistivity of approximately ∞ and heat resistance went beyond approximately 800° C.

Reactive Polymers

Reactive polymer can react with RNS and reactive insulating GHC to form a rigid structure network that is resistant to heat damage.

Reactive polymers can be crosslinking polymers such as, but not limited to, thermosetting plastics, natural rubber, synthetic rubber, epoxy, melamine formaldehyde, urea formaldehyde, poly amic, polyimide, hydroxylated polymers, vinyl ester resin, poly vinylsilane, and the like. These crosslinking polymers can form a network under high heat and/or irradiation with ultraviolet radiation and/or X-rays.

Electrocatalyst

Noble metals such as Pt, Pd, Ru, Pt—Sn, Pt—Co, Ni had been known as H₂ fuel oxidizer producing protons (H⁺) and electrons. These catalysts can be adsorbed onto a highly conductive porous substrate in contact with proton transport media, which acts as a separator to detach geminate electrons from geminate protons as quickly as possible to avoid recombination. An exemplary electrocatalyst Pt/C, where C can be Vulcan XR72C (available from Cabot Corporation) having a specific surface area (“SSA”) by a Brunauer-Emmett-Teller (“BET”) measurement of approximately 220 m²/g and bulk electrical resistivity of approximately 350 mΩ. In order to improve power efficiency, noble metal catalysts such as Pt can be utilized with nano particles, which can fit in a nano pore of a porous conductive substrate as strong and tight as possible. The highly conductive porous substrate can be obtained from engraved GHC and reactive GHC as disclosed in United States Patent Publication 20180298157 and U.S. patent Ser. No. 10/501,324, each of which is incorporated by reference herein in its entirety. In certain exemplary embodiments, engraved GHC and reactive GHC exhibits a bulk electrical resistivity that is several to ten times lower than that of Vulcan R72C and has an SSA that is approximately seven to eight times larger than that of Vulcan XR72C. The following examples clarify the role of nano materials in enhancing power efficiency of fuel cells.

Example 1—Preparation of an anode—In an exemplary embodiment, approximately 17 grams of H₂PtCl₆ (approximately 20% in water) and approximately 10 grams RuCl₃ (approximately 10% in water) and approximately 0.5 gram of engraved graphene (see, United States Patent Publication 20180298157 for how to obtain engraved GHC) and 0.5 g of reactive GHC (see U.S. patent Ser. No. 10/501,324 for how to obtain reactive GHC) having a specific surface area (SSA by BET) of approximately 1730 m²/g, a bulk electrical resistivity of approximately 15 mΩ and average particle size of approximately 20 nm were dispersed in approximately 40 grams of distilled water at approximately 50° C. using mechanical stirrer for approximately 30 minutes. Then approximately 250 grams of NaBH₄ (approximately 10% in D.I water) was added drop wise and the pH was adjusted to be approximately 6. The mixture was filtered to collect solids, then baked in a convection oven at approximately 100° C. for approximately 2 hours to achieve nano (Pt—Ru)/GHC. Nano (Pt—Ru)/GHC powder was mixed with acetone using an ultrasonic mixer to form a thick slurry, which slurry was paint brushed onto Toray Carbon Paper (TCP) (the TCP having an area of approximately 300 cm²), and the TCP was baked in a convection oven for approximately two hours to form a fuel cell anode.

Example 2—Preparation of a cathode—Repeat the process of Example 1 except that RuCl₃ was not added to achieve a nano Pt/GHC. Then the nano Pt/GHC powder was processed in the same way with Example 1 to form a fuel cell cathode.

Example 3—Preparation of fuel cell—A sheet of Nafion 115 (available from Fuel Cell Store Company), having area of approximately 400 cm², was sandwiched between the aforementioned anode and cathode via a hot-pressure device set at approximately 70° C. for approximately 15 minutes. The set of anode/Nafion 115/cathode was assembled into a bipolar electrochemical cell. The cell was detected to provide a power output of approximately 0.15 W/cm² at approximately room temperature (i.e., approximately 25° C.).

Comparison Example 4—Repeat the processes of example 1 and 2 except that engraved GHC and reactive GHC are replaced by carbon black Vulcan XR72C (available from Cabot), having a SSA of approximately 220 m²/g, bulk electrical resistivity of approximately 350 mΩ and an average particle size of approximately 3 um to form an anode and cathode.

Comparison Example 5—Repeat the process of example 3 except the anode and cathode are made from the process of Example 4. The cell was detected to provide a power output of approximately 0.005 W/cm² at approximately room temperature (i.e., approximately 25° C.).

From these experimental results, one can see that GHC shows an increase of approximately thirty times in power efficiency over exemplary Pt/C electrocatalysts.

### High Temperature Proton Transport Membrane

### Functional Disturber

Example 6—Preparation of sulfonic acid functionalized silica—approximately 100 grams silica gel (India, silica gel sized at approximately 200-400 mesh) was milled with high power shear for approximately five minutes into a nano powder having average particle size of approximately 50 nm. The nano powder of silica gel was slowly added into approximately 200 grams concentrated sulfuric acid while being stirred at approximately 70° C. by a magnetic stirrer for approximately three hours. The mixture silica gel-sulfuric acid was heated to approximately 100° C. to evaporate some water. The slurry was baked at approximately 120° C. in a furnace to achieve a white solid.

Example 7—Preparation of RNS containing sulfonic acid functionalized disturber—in a beaker equipped with mechanical stirrer, approximately 40 grams of NaOH was dissolved in approximately 100 grams tap water. Then approximately 50 grams of dried SAC gel was added and stirred until completely dissolved. Next approximately 20 grams of sulfonic acid functionalized silica gel mentioned in Example 6 was added, one drop of surfactant Surfynol 465 (Surfynol is a registered trademark of Evonik Degussa GMBH of Germany) was added and stirred at approximately 70° C. for approximately three hours to achieve a white dispersion having approximately 25% solids by weight. This suspension was an RNS product containing sulfonic acid functionalized silica disturber.

FIG. 3 is a transmission electron microscopy (“TEM”) image 3000 of SAC (left) and RNS (right) (scale 200 nm). In an exemplary embodiment, the TEM image of the SAC gel and the RNS having sulfonic acid functionalized disturber was illustrated in FIG. 3. One can recognize that SAC appears as an individual particle while RNS shows a particle connected to a cloudy membrane.

FIG. 4 is a graph 4000 of TGA data of exemplary SAC and RNS. In an exemplary embodiment, the TGA data of SAC gel 4100, sulfonic acid functionalized silica gel (example 6) 4200, and the RNS having sulfonic acid functionalized disturber (example 7) 4300 are illustrated in FIG. 4.

It was determined that SAC gel is substantially thermally decomposed at approximately 150° C. while RNS continued to survive beyond approximately 800° C., which confirmed heat resistant properties of RNS carrying proton transport functionality.

Example 8—Repeat example 7 except 3-(Trihydroxysilyl) propane-1-sulfonic acid was replaced for sulfonic acid functionalized silica.

Example 9—PVA/chlorosulfonic acid approximately 50 grams polyvinyl acetate (having a molecular weight of approximately 100,000 and available from Aldrich) was dissolved in warm water set at approximately 70° C. Then approximately 30 g of chlorosulfonic acid (CAS #7790-94-5; available from Parchem) was added drop-wise into it until the pH reached approximately 5.

Example 10—repeat example 3 except that Nafion 115 is replaced by RNS carrying sulfonic acid functionalized silica gel described in example 7. The cell power output was detected to be approximately 0.14 W/cm² at room temperature (i.e., approximately 25° C.) and about 0.69 W/cm² at approximately 800° C.

FIG. 5 is a schematic diagram 5000 of power generator operating with water, which illustrates utilizations of water 001, water plus a reducing agent 002, H₂ gas generating cartridge 003, H₂ gas 004, fuel cell 005, strong heat 006, light heat 006 bis, high heat source 007, substantially pure water 008, and electricity 009.

Example 11—In order to test out the example 10, a power generator system described in FIG. 5 was built. FIG. 6 is H₂ gas generating cartridge 6000, which comprises water plus a reducing agent 002 (see also FIG. 5), H₂ gas 004 (see also FIG. 5), an ABS block 010, a well-shaped micro-reactor 011, a water reducing metal 012 deposited by a shadow mask using a vacuum separator, and a cover lid 013. In this example, water was reduced into H² gas using reaction of Al—Li alloy and KOH/NaOH/NaBH₄ (1/1) through an H₂ generating cartridge described in FIG. 6. Cartridge 6000 can provide H₂ gas on demand and it can be exchanged into a new one after the Al—Li alloy is spent. Cartridge 6000 can be prepared through several STEPS;
at step 1 ABS block 010 (acrylonitrile/butadiene/styrene) copolymer (engineering polymer) is supplied;
at step 2 ABS block 010 is carved into well shape micro-reactors 011;
at step 3 well shape micro-reactors 011 are filled in with a suitable Al—Li alloy layer by a vacuum evaporator and shadow mask and/or by electro-deposition of Al—Li by electrolysis of an AlCl₃/LiCl solution;
STEP 4 micro-reactor 011 is filled in with solution of reducing agent (water/KOH/NaOH/NaBH₄);
when reducing agent solution in touch with deposited Al—Li layer in the well shape micro-reactor, the reaction occurs right away regenerating H₂ gas and heat;
the H₂ gas and heat is provided to fuel cell system in the bipolar;
when Al—Li alloy is consumed off, the H₂ generating cartridge is replaced by the new one to keep H₂ level steady; and
in order to increase power efficiency, the bipolar (see, United States Patent Application 20130177823, which is incorporated by reference herein in its entirety) is heated up with 2nd heat source laying on the top of bipolar, which can provide chamber temperature up to approximately 1000° C.

The heat source can be a thermo resistor or an infrared light. The most efficient bipolar found was made out of copper.

### Other Configurations of Fuel Cell: Hybrid Power Generator

A fuel cell is a device producing power by the ionization of fuel. The ionization potential to separate electrons from ions is much larger than that of potential separating electrons from holes in photoconductivity. Exemplary power generators should consume less energy and produce more power. A disadvantage of certain SOFCs is the utilization of a large heat source to produce power.

FIG. 7 is an exemplary hybrid power generator system 7000 from water and solar cell, which comprises elements also illustrated in FIG. 5 (water 001, water plus a reducing agent 002, H₂ gas generating cartridge 003, H₂ gas 004, fuel cell 005, strong heat 006, light heat 006 bis, high heat source 007, and substantially pure water 008). System 7000 further comprises a super capacitor 014 and a solar cell 015.

In certain exemplary embodiments, a fuel cell heat source is replaced by a separate solar cell (e.g., solar cell 015) to form a hybrid power generator system as indicated in FIG. 7.

In another exemplary of the embodiment, the solar cell unit is incorporated into the fuel cell utilizing photoconductivity effect of composite silver halide AgX/GHC. This effect is disclosed in U.S. Pat. No. 9,281,426, which is incorporated by reference in its entirety.

FIG. 8 is an exemplary hybrid power generator system 8000 from H2 fuel cell and AgX solar cell, which comprises a conductive porous substrate 016, engraved GHC 017, a nano catalyst (e.g., Pt, Ru) 018, AgX layer 019, a proton transporter 020, a transparent electrode 021, a proton an electron transporter (e.g., polystyrene sulfonic acid) 022, an electron donor developer 023, and a solid electrolyte 8100. The AgX layer transports protons from H₂ to the cathode, and AgX layer also transports electrons to the anode, AgX can be dispersed in a polymer, which can transport both electrons and protons. Examples of polymers constructed to transport both electrons and protons comprise:

Polystyrene sulfonic acid and poly perylene sulfonic acid:

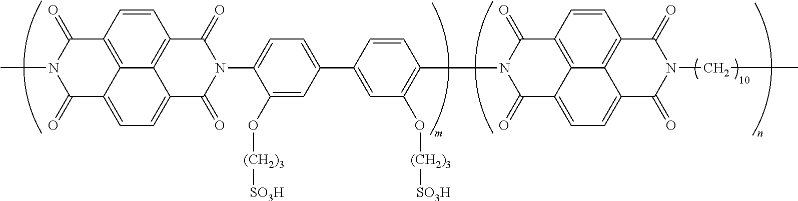

Efforts to Eliminate High Heat Source for High Power Generator

Certain exemplary embodiments provide a device comprising AgX and a photoconductor. Electrons from light exposed AgX can be amplified by electron donating molecules 9400 such as, but not limited to, NaOH and KOH.

Electrons from light exposed AgX can be amplified by photoelectrons 9400 of the photoconductor. In this case photoelectrons 9400 provided by the photoconductor can reduce X atom into X⁻ ion which reacts with Ag⁺ ion to receive photoeffects again and again. Thus, the hybrid of AgX and the photoconductor under electric fields generate novel amplified solar cell system, which operates at approximately room temperature.

Certain exemplary embodiments provide a device. The device comprises solid electrolyte 8100. Solid electrolyte 8100 comprises a reactive nano silicate precursor. The reactive nano silicate precursor is activated by a functional disturber. The functional disturber having a first end that is reactive with a silica/acid composite gel and a second end capable of transporting an ion. The functional disturber comprises a metal oxide capable of withdrawing an electron from the silica/acid composite gel.

In certain exemplary embodiments:
the metal oxide transports an oxygen ion;
the metal oxide transports a proton;
solid electrolyte 8100 can comprise a sulfonic acid derivative that acts as a proton transporter;
solid electrolyte 8100 can comprise sulfonic acid (see, e.g., proton an electron transporter 022);
the sulfonic acid acts as a proton transporter;
the solid electrolyte can comprise a sulfonic acid derivative that acts as a proton transporter (see, e.g., proton an electron transporter 022);
the sulfonic acid derivative can be a sulfonic acid functionalized material that comprises silica;
solid electrolyte 8100 can comprise sulfonic acid;
solid electrolyte 8100 can comprise a material comprising functionalized silica;
the functionalized silica can comprise one or more of silica gel, poly silica, pyro silicic acid, and aerogel;
solid electrolyte 8100 can comprise a sulfonic acid derivative that acts as a proton transporter;
the sulfonic acid derivative can be a reactive polymer;
the reactive polymer is constructed to react with the reactive nano silicate precursor and transport protons;
the reactive polymer can be a hydroxylated polymer or copolymer of poly vinyl alcohol (PVA), polyvinyl chloride, poly vinyl sulfonic acid, polydimethyl siloxane, and/or a polyester, etc.
solid electrolyte 8100 can comprise a sulfonic acid derivative that acts as a proton transporter;
the sulfonic acid derivative can be a reactive polymer;
the reactive polymer is constructed to react with RNS and transport protons;
the reactive copolymer has a structure of:

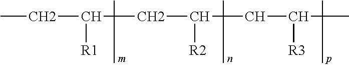

where:
   R1 comprises one or more of H, —SO₃H, —NHSO₃H, —OSO₃H, -alkyl-SO₃H;
   R2 comprises one or more of H, —OH, —CH₂CH₂OH, -alkyl-OH, —Cl;
   R3═—OCOR4;
   R4=alkyl; and
   m>80, n<10, p<10
proton mobility is enhanced with electron donor molecule, the electron donor molecule one of NaOH, KOH, sodium bicarbonate, CaCO₃, Ca(OH)₂, Al(OH)₃, ammonia borane; dichloroamine, hydroxylamine, monochloroamine, nitrogen trihalogenide;
the device can be a fuel cell;
the device can be a hybrid fuel cell
the device can be a battery;
the device can be a capacitor;
the solid electrolyte comprises a reactive graphene hybrid composite, the reactive graphene hybrid composite acts as a non-electronic transport;
solid electrolyte 8100 can comprise a crosslinking polymer, the crosslinking polymer comprising one or more of a thermosetting plastic, natural rubber, synthetic rubber, epoxy, hydroxylated polymer, vinyl ester resin, and poly vinylsilane;
the device is an anode or cathode of a planar fuel cell or a tubular fuel cell;
the fuel cell can be constructed to operate between 25° C. and 1000° C.;
the fuel cell can be constructed to operate with water via an H₂ generating cartridge;
fuel cell H₂ is generated by Al alloys and a reducing agent;
the anode or cathode can comprise a nano carbon based nano catalyst;
the solid electrolyte can comprise engraved GHC;
the solid electrolyte can comprise an electroconductive nanomaterial having specific surface area (SSA by BET) greater than 1730 m²/g;
the device can be constructed to generate electrical power utilizing water via an H₂ generating cartridge; and/or
the device can be constructed to generate electrical power utilizing a solar cell, the solar cell is based on a photoconductor, the photoconductor utilizing photosensitivity of a silver halide, an electron source of the silver halide accelerated via electric field, etc.

An exemplary hybrid power generator is illustrated in FIG. 8. In FIG. 8, a solar cell unit comprises silver halide grains such as AgBr, AgCl, AgI, which can be dispersed in a polystyrene sulfonic acid solution (e.g., approximately 10% in water). The polystyrene sulfonic acid can transport both electrons and protons. This photosensitive layer can be paint brushed directly onto an engraved GHC/nano Pt (nano Ru) layer such as described in Example 1 and Example 3.

In the configuration of hybrid power system described in FIG. 8, a first power source comes from the ionization of H₂ when H₂ gas hits nano catalyst 018 (e.g., Pt/Ru), it is ionized into proton H⁺ migrating through layer 022 (e.g., polystyrene sulfonic acid) and AgX layer 019 and then via a substantially pure Nafion layer to reach a cathode. Electrons migrate to an anode through engraved GHC layer 017 thereby generating power from the first power source.

On the other hand, sunlight hits a photosensitive layer through transparent cathode forming electron generating a second power source. The power generation mechanism is described in FIG. 9.

FIG. 9 is power generation mechanism 9000 of silver halide, AgX, which illustrates a photographic process 9100, a power generation process 9200, a sensitivity center 9300, and a developer (i.e., an electron donor) 9400, which produces power 9500.

In exemplary traditional photographic processes, AgX molecules are split into an Ag⁺ cation and an X⁻ anion; when AgX hits the light, then X⁻ proceeds to X atom thereby releasing an electron. This electron migrates to attack Ag⁺ (latent image) via sensitivity center 9300 and renders it into Ag atom (visible image). Such an electron can be called an amplified electron.

In the process of producing power, in certain exemplary embodiments, the amplified electron is collected by an electric field forming second power source.

The X atom is then oxidized by electron donor developer 9400 into X⁻ ion which combines with Ag+ ion (U.S. Pat. No. 9,281,426) to undergo the photo effect again.

The electron and proton recombine at the cathode generating substantially pure water.

With exemplary hybrid mechanism fuel cell power can be approximately doubled, compared to exemplary alternatives, without high heat source.

FIG. 10 is an exemplary system 10000, which is a hybrid solar cell of AgX and a photoconductor. System 10000 comprises the sun 10100, a photo electron from AgX⁻ 10200, an electron and hole 10300 from a photoconductor, a transparent electrode (“ITO”) 10400, gelatin 10500, a power generation process 10600, a photoconductor 10700, a electrical field 10800, and generated electrical power 10900.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
accelerate—to have a time rate of change in the velocity of something.
act—to do something.
activity—an action, act, step, and/or process or portion thereof
adapter—a device used to effect operative compatibility between different parts of one or more pieces of an apparatus or system.
aerogel—a light, highly porous solid formed by replacement of liquid in a gel with a gas so that the resulting solid is the same size as the original.
alkyl-comprising a monovalent organic group and especially one CnH₂ₙ₊₁ (such as methyl) derived from an alkane (such as methane).
alloy—a substance comprising two or more metals or of a metal and a nonmetal intimately united usually by being fused together and dissolving in each other when molten. For example, aluminum, copper, bronze, brass, cadmium, chromium, gold, iron, lead, palladium, silver, sterling, stainless, zinc platinum, titanium, magnesium, anatomy, bismuth, nickel, and/or tin, etc.
and/or—either in conjunction with or in alternative to.
anode—an electrode through which the conventional current enters into a polarized electrical device.
apparatus—an appliance or device for a particular purpose
associate—to join, connect together, and/or relate.
based—comprising as an important component.
battery—one or more electrochemical cells adapted to convert stored chemical energy into electrical energy.
can—is capable of, in at least some embodiments.
capable—having an ability to function in a certain manner.
capacitor—a passive electronic component that holds a charge in the form of an electrostatic field.
cartridge—a container that holds a substance.
cathode—an electrode through which the conventional current exits out of a polarized electrical device.
cause—to produce an effect.
comprising—including but not limited to.
configure—to make suitable or fit for a specific use or situation.
connect—to join or fasten together.
constructed to—made to and/or designed to.
convert—to transform, adapt, and/or change.
copolymer—a product of the polymerization of two substances.
coupleable—capable of being joined, connected, and/or linked together.
coupling—linking in some fashion.
create—to bring into being.
crosslink—a crosswise connecting part (such as an atom or group) that connects parallel chains in a complex chemical molecule (such as a polymer).
define—to establish the outline, form, or structure of
derivative—a chemical substance related structurally to another substance and theoretically derivable from it.
determine—to obtain, calculate, decide, deduce, and/or ascertain.
device—a machine, manufacture, and/or collection thereof.
donor—a substance capable of giving up a part for combination with an acceptor.
electric field—a spatial force array that surrounds an electric charge, and exerts force on other charges in the field, attracting or repelling them.
electroconductive—capable of conducting electricity.
electrolyte—a nonmetallic electric conductor in which current is carried by the movement of ions.
electron—a very small particle that has a negative charge of electricity and travels around the nucleus of an atom.
end—a most extreme part of a molecule.
engrave—to carve or etch a material in a manner that increases surface porosity.
enhance—to increase a property of something.
estimate—to calculate and/or determine approximately and/or tentatively.
fuel cell—an electrochemical cell that converts the chemical energy of a fuel and an oxidizing agent into electricity through a pair of redox reactions.
functional disturber—a substance that can convert a silica/acid composite into a more reactive species named as reactive nano silica (“RNS”).
functional group—a group of atoms responsible for the characteristic reactions of a particular compound.
functionalized material—a substance that comprises a functional group.
gel—a colloid in a more solid form than a colloidal fluid.
generate—to create, produce, give rise to, and/or bring into existence.
graphene hybrid composite (“GHC”)—a substance comprising graphene as described in U.S. Pat. No. 9,460,827, which is incorporated by reference in its entirety, which substance comprises carbon nanotubes.
hybrid—something (such as an energy generating system) that has two different types of components performing essentially the same function.
hydroxylated—comprising a chemical group, ion, or radical OH that comprises of one atom of hydrogen and one of oxygen and is neutral or negatively charged.
install—to connect or set in position and prepare for use.
ion—an atom or group of atoms that carries a positive or negative electric charge as a result of having lost or gained one or more electrons.
location—a place where something physically exists.
may—is allowed and/or permitted to, in at least some embodiments.
metal—a solid material that is typically hard, shiny, malleable, fusible, and ductile, with good electrical and thermal conductivity (e.g., iron, gold, silver, copper, and aluminum, and alloys such as brass and steel).
method—a process, procedure, and/or collection of related activities for accomplishing something.
mobility—an ability to move from one location to another.
molecule—a smallest particle of a substance that retains all properties of the substance and comprises one or more atoms.
nano carbon—a carbon particle with an average major diameter of less than 100 nanometers, including all values and all subranges therebetween.
nano catalyst—a substance with an average major diameter of less than 100 nanometers that enables a chemical reaction to proceed at a usually faster rate or under different conditions (as at a lower temperature) than otherwise possible without being consumed by the chemical reaction.
nanomaterial—a particle with an average major diameter of less than 100 nanometers, including all values and all subranges therebetween.
natural—grown without human care.
non-electronic—taking place via energy other than energy from electrons.
operate—to control a function of.
oxide—a compound in which oxygen is chemically bonded with a more electropositive element or group.
photoconductor—a material that becomes more electrically conductive due to the absorption of electromagnetic radiation such as visible light, ultraviolet light, infrared light, or gamma radiation.
photosensitivity —the amount to which an object reacts upon receiving photons, especially visible light.
planar—having a substantially flat surface.
plurality—the state of being plural and/or more than one.
polymer—a large molecule, or macromolecule, composed of many repeated subunits.
predetermined—established in advance.
project—to calculate, estimate, or predict.
proton—a very small particle of matter that is part of the nucleus of an atom and that has a positive electrical charge.
provide—to furnish, supply, give, and/or make available.
reactive—capable of reacting relatively quickly with substances.
reactive graphene hybrid composite—a substance comprising graphene as described in U.S. Pat. Nos. 9,460,827 and 10,501,324 each of which is incorporated by reference herein in its entirety, which substance comprises carbon nanotubes.
reactive nano silicate precursor (“RNS”)—a product of silica/acid composite gel disclosed in United States Patent Publication 20180099905.
receive—to get as a signal, take, acquire, and/or obtain.
reducing agent—an element or compound that loses an electron to an electron recipient in a redox chemical reaction.
repeatedly—again and again; repetitively.
request—to express a desire for and/or ask for.
rubber—such as, for example, elastomer, natural rubber, nitrile rubber, silicone rubber, acrylic rubber, neoprene, butyl rubber, flurosilicone, TFE, SBR, and/or styrene butadiene, etc.
select—to make a choice or selection from alternatives.
set—a related plurality.
silica/acid composite—a substance comprising a silica core and having a specific acidic shell. The substance having a X-ray diffraction chart with diffraction peaks appearing at approximately two theta=2°, 27.75°, 41°.
solar cell—an electrical device that converts the energy of light directly into electricity by the photovoltaic effect.
solid—a substance that does not flow perceptibly under moderate stress, has a definite capacity for resisting forces (such as compression or tension) which tend to deform it, and under ordinary conditions retains a definite size and shape.
source—an origin of something.
specific surface area—a property of solids defined as the total surface area of a material per unit of mass.
store—to place, hold, and/or retain.
substantially—to a great extent or degree.
sulfonic acid—an organic acid containing the group —SO₂OH.
support—to bear the weight of, especially from below.
synthetic—produced artificially with human intervention.
system—a collection of mechanisms, devices, machines, articles of manufacture, processes, data, and/or instructions, the collection designed to perform one or more specific functions.
thermosetting plastic—a polymer that is irreversibly hardened by curing from a soft solid or viscous liquid prepolymer or resin. Curing is induced by heat or suitable radiation and may be promoted by high pressure, or mixing with a catalyst.
transmit—to send, provide, furnish, and/or supply.
transport—to carry, move, or convey from one location to another.
trihalogenide—comprising three atoms from the group Br, Cl, and I.
tubular—having a general form of an elongated cylinder.
utilize—to put to use.
via—by way of and/or utilizing.
weight—a value indicative of importance.
withdraw—to take away.

### NOTE

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a device, the device comprising a solid electrolyte, the solid electrolyte comprising a reactive nano silicate precursor, the reactive nano silicate precursor activated by a functional disturber, the functional disturber having a first end that is reactive with a silica/acid composite gel and a second end capable of transporting an ion, the functional disturber comprising a metal oxide capable of withdrawing an electron from the silica/acid composite gel.

2. The system of claim 1, wherein:
the metal oxide transports an oxygen ion.

3. The system of claim 1, wherein:
the metal oxide transports a proton.

4. The system of claim 1, wherein:
the solid electrolyte comprises sulfonic acid;
the solid electrolyte comprises a material comprising functionalized silica; and
the functionalized silica comprises one or more of silica gel, poly silica, pyro silicic acid, and aerogel.

5. The system of claim 1, wherein:
the solid electrolyte comprises a sulfonic acid derivative that acts as a proton transporter;
the sulfonic acid derivative is a reactive polymer;
the reactive polymer is constructed to react with the reactive nano silicate precursor and transport protons; and
the reactive polymer is a hydroxylated polymer or copolymer of poly vinyl alcohol (PVA), polyvinyl chloride, poly vinyl sulfonic acid, polydimethyl siloxane, or a polyester.

6. The system of claim 1, wherein:
the solid electrolyte comprises a sulfonic acid derivative that acts as a proton transporter;
the sulfonic acid derivative is a reactive polymer;
the reactive polymer is constructed to react with RNS and transport protons; and
the reactive copolymer has a structure of: 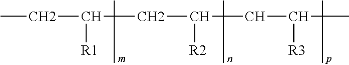
where:
R1 comprises one or more of H, —SO₃H, —NHSO₃H, —OSO₃H, -alkyl-SO₃H;
R2 comprises one or more of H, —OH, —CH₂CH₂OH, -alkyl-OH, —Cl;
R3═—OCOR4;
R4=alkyl; and
m>80, n<10, p<10

7. The system of claim 1, wherein:
proton mobility is enhanced with electron donor molecule, the electron donor molecule one of NaOH, KOH, sodium bicarbonate, CaCO₃, Ca(OH)₂, Al(OH)₃, ammonia borane, dichloroamine, hydroxylamine, monochloroamine, nitrogen trihalogenide.

8. The system of claim 1, wherein:
the device is a fuel cell or a hybrid fuel cell.

9. The system of claim 1, wherein:
the device is a battery.

10. The system of claim 1, wherein:
the device is a capacitor.

11. The system of claim 1, wherein:
the solid electrolyte comprises a reactive graphene hybrid composite, the reactive graphene hybrid composite acts as a non-electronic transport.

12. The system of claim 1, wherein:
the solid electrolyte comprises a crosslinking polymer, the crosslinking polymer comprising one or more of a thermosetting plastic, natural rubber, synthetic rubber, epoxy, hydroxylated polymer, vinyl ester resin, and poly vinylsilane.

13. The system of claim 1, wherein:
the device is an anode or cathode of a planar fuel cell or a tubular fuel cell;
the fuel cell is constructed to operate between 25° C. and 1000° C.;
the fuel cell is constructed to operate with water via an H₂ generating cartridge;
fuel cell H₂ is generated by Al alloys and a reducing agent; and
the anode or cathode comprises a nano carbon based nano catalyst.

14. The system of claim 1, wherein:
the solid electrolyte comprises engraved GHC.

15. The system of claim 1, wherein:
the solid electrolyte comprises an electroconductive nanomaterial having specific surface area (SSA by BET) greater than 1730 m²/g.

16. The system of claim 1, wherein:
the device constructed to generate electrical power utilizing water via an H₂ generating cartridge.

17. The system of claim 1, wherein:
the device constructed to generate electrical power utilizing a solar cell, the solar cell is based on a silver halide and a photoconductor, the photoconductor utilizing photosensitivity of the silver halide, an electron source of the silver halide accelerated via electric field.
